(19) United States
(12) Patent Application Publication
(10) Pub. No.: US 2011/0095103 A1
(43) Pub. Date: Apr. 28, 2011

(54) Product release system to atomize cosmetic hair and skin cleaning compositions

(76) Inventors: Hartmut Schiemann, Hunfeld (DE); Thomas Krause, Darmstadt (DE); Michael Franzke, Robdorf (DE); Dirk Weber, Marly (CH); Monika Moenks, Schmitten (CH); Jan Baumeister, Farvagny-le-Grand (CH); Ellen Florig, Grasellenbach (DE)

(21) Appl. No.: 11/471,449

(22) Filed: Jun. 20, 2006

(30) Foreign Application Priority Data
Jun. 20, 2005 (DE) 102005028386.1

(51) Int. Cl. B05B 1/00

(52) U.S. Cl. 239/589

(57) ABSTRACT

A product release system for atomizing cosmetic hair or skin cleaning compositions is described, which has (a) pressure-resistant packaging, (b) a capillary-containing spray head, and (c) a propellant-containing cosmetic composition, which contains at least one wash-active surfactant. The atomization is done using the capillary. The capillary preferably has a diameter of 0.1 to 1 mm and a length of 5 to 100 mm. The spray rate is preferably 0.01 to 5 g/s. The composition can particularly be gel-like.

The object of the present invention is a product release system for atomizing cosmetic hair or skin compositions, which has pressure-resistant packaging, a capillary-containing spray head, and a propellant-containing cosmetic composition, and wherein the composition contains at least one wash-active surfactant. The object of the invention is also a corresponding method for hair and skin treatment.

Cosmetic preparations used for cleaning hair and the body, such as shower gels, foam baths, hair shampoos, etc., are based mainly on anionic wash-active surfactants such as alkyl sulfates, alpha-olefin sulfonates, and alkylether sulfates. The primary requirement placed on such types of agents is to remove sweat, grease, and dirt particles on the skin and hair without causing skin irritations. In skin-friendlier formulations for daily use, so-called secondary surfactants can partially replace the aforementioned anionic surfactants. The materials have significantly less irritation effect, for example alkyl polyglucosides, betaines, glycinates, surfactant protein derivatives, ether carboxylates, and sulfosuccinates. Although the irritation effect is significantly reduced when secondary surfactants are used, it is associated with technical disadvantages in usage such as poor foaming behavior. In addition, with body cleaning agents, consumers want the most pleasant feel possible of the product mass on the skin. Many body cleaning agents also contain ingredients such as hair-conditioning ingredients, moisturizing materials, or anti-dandruff ingredients. Hair-conditioning ingredients are materials having at least one hair-care effect such as, for example, improving combing properties in wet hair or dry hair, improving the hold of the hair when wet or dry, improving the shine of the hair, or reducing the flyaway effect. Hair-conditioning ingredients are, in particular, silicone compounds and cationic polymers. In order to stabilize the additional ingredients, often a higher viscosity or reduced flow capacity is required, whereby the product removal, the applicability, and the initial foaming behavior are influenced, particularly with products containing skin-friendly, secondary surfactants. The products currently on the market are typically dispensed from the packaging in an un-foamed condition and put in the hands, lightly distributed between the hands, applied to the skin or the hair, and then worked into a foam. Previously, it was not possible to dispense and foam up higher viscosity or non-fluid formulations from the packaging with as much precision as can be obtained with low-viscosity products. Liquid products with a lower viscosity are easier to extract and easier to distribute; however, these products often do not contain all the desired active ingredients and additives in a stable form and often have a less intensive hair- and skin-conditioning and hair- or scalp-care effect. In addition, it has been difficult in the past to apply shampoos containing skin ingredients directly and precisely to the scalp.

A process for atomizing liquid is known from WO 03/051523 A1 with which the spray is formed using a capillary. Only the application with respect to atomizing liquid, i.e., fluid, compositions is described. A fixture for atomizing liquid products is described in WO 03/051522 A2, wherein the spray is formed using a capillary. Only the use of liquid, i.e., fluid, compositions, which can also be highly viscous, for atomizing is described, wherein the maximum sprayable viscosity is 5,000 mPa s.

Thus, there is a need for body cleaning products, which, on one hand, are skin-friendly, contain stable hair- and skin-conditioning ingredients, and that also can be well dispensed from the packaging, foam up well, and provide the best possible feel on the skin during application. In doing so, the hair-conditioning and skin-conditioning effects should correspond to those of highly viscous cleaning agents, or even go beyond the effects of previously known products.

The object of the invention is a product release system for atomizing cosmetic cleaning compositions. The product release system has the following features:

(a) pressure-resistant packaging;

(b) a spray head containing a capillary; and

(c) a propellant-containing cosmetic composition,

wherein the atomization is done using the capillary and the composition contains at least one wash-active surfactant.

The term “atomize” is understood to mean the release of the product in the form of dissipated particles. The dissipated particles can have varying shapes, consistency, and sizes. The properties of the atomized particles can include everything from fine aerosol atomized spray to liquid drops, snow-like drops, solid spray flakes, and spray foam.

The quantities of ingredients (e.g., wt. %) indicated in the following are each based on the basic composition without propellant unless explicitly indicated otherwise. The quantities of the propellant are based on the total composition including propellant. The properties of the compositions to be used according to the invention that are related to consistency are based on the base composition without propellant (unless explicitly indicated otherwise). Non-liquid compositions in terms of the invention are particularly non-flow-capable compositions, which, for example, can be determined due to the fact that they will not flow off of a glass surface tilted at 45° at a temperature of 25° C. Gel compositions are characterized in that the memory module G′ is larger than the loss module G″ at 25° C. with oscillographic measurements in the typical measurement range (0.01 to 40 Hz).

The composition is preferably non-liquid at 25° C. and/or has a viscosity of greater than 1000, or particularly greater than 2,000 or greater than 5,000 mPa s and up to 100,000, or particularly preferably up to 50,000 or up to 35,000 mPa s measured with a HAAKE VT-550 Rheometer, SV-DIN test body at a temperature of 25° C. and a shear speed of 12.9 s⁻¹.

Aerosol spray cans constructed of metal or plastic can be used as the pressure-resistant packaging. Preferred metals are tin plates and aluminum, while the preferred plastic is polyethylene terephthalate.

Suitable spray systems with capillary-containing spray heads, with which the spray is formed using a capillary, are described in WO 03/051523 A1 and in WO 03/051522 A2. The capillaries preferably have a diameter of 0.1 to 1 mm, or particularly 0.2 to 0.6 mm, and a length that is preferably 5 to 100 mm, or particularly 5 to 50 mm. The spray principle is also described in Aerosol Europe, vol. 13, no. 1-2005, pages 6-11. The spray system is based on the principle of capillary atomization. The conventional swirl nozzle as well as, if necessary, the uptake tube are replaced by capillaries. The energy-consuming and propellant-intensive swirling of the content of the can and the required strong dilution of the product with solvents is not necessary as compared to conventional spray systems. Even if only a small quantity of propellant is used, the product rises upward on the wall of the uptake tube capillary and is propelled, after the valve in the (wider) capillary of the spray head, in the direction of the exit opening. In this manner, small drops from the flowing propellant are torn from the surface of the liquid and continue to flow as aerosol. Since there is no swirl chamber to inhibit the flow of the product nor any atomizing nozzle available, the energy in the system can be used much more efficiently to create the desired spray. The spray rate can be adjusted via the selection of the capillary geometry in conjunction with the interior pressure created by the propellant or a propellant mixture. Preferred spray rates are 0.0105 to 0.5 g/s, particularly 0.1 to 0.3 g/s. The size of the spray drops created with the atomization can be adjusted via the selection of the capillary geometry in conjunction with the interior pressure or the viscosity of the composition. Suitable capillary atomization systems can be obtained in a product called TRUSPRAY® from Boehringer Ingelheim microParts GmbH.

The preferred drop size distributions are those with which the dv(50) value is a maximum of 200 μm, e.g., of from 50 to 200 μm with a maximum of 100 μm being especially preferred, e.g., of from 70 to 90 μm and/or with which the dv(90) value is a maximum of 160 μm, e.g., of from 90 to 160 μm, with a maximum of 150 μm being especially preferred, e.g., of from 115 to 150 μm. The dv(50) or dv(90) values provide the maximum diameter, which 50% or 90% of a droplets have. The drop size distribution can, for example, be determined with the help of a particle measurement unit based on laser beam diffraction, e.g., a Malvern particle sizer measuring device. Compositions that form a snow-like consistency, flakes, or foam (spray foam) upon exiting the capillary spray system are also preferred.

The propellant to be used can be selected from lower alkanes, particularly C3 to C5 hydrocarbons such as, for example, n-butane, i-butane, and propane, or also mixtures thereof, as well as dimethylethers or fluorine hydrocarbons such as F 152a (1,1-difluoroethane) or F 134 (tetrafluoroethane) as well as other gaseous propellants present with the pressures considered, such as, for example, N₂, N₂O, and CO₂ as well as mixtures of the aforementioned propellants. The propellant is preferably selected from propane, n-butane, isobutane, dimethylether, fluorinated hydrocarbons, and mixtures thereof. The propellant content is additionally preferably 15 to 85 wt. %, with 25 to 75 wt. % being especially preferred. Preferred mixtures of propane and butane are those with a pressure of between 2 and 6 bar, or particularly of between 4 and 5 bar, at 20° C.

Embodiments with dimethyl ether as a propellant are particularly suitable for product release in the form of a fine aerosol spray. In this case, it is particularly advantageous if skin ingredients, for example, shampoos containing anti-dandruff agents, are sprayed directly at the roots to improve effectiveness. Embodiments with propane or butane as a propellant are particularly suitable for product release in the form of a snow-like spray or flakes of spray with a particularly advantageous feel on the skin during use.

The cleaning composition contains cosmetically acceptable solvents, preferably an aqueous medium. The water content is preferably between 15 and 80 wt. %. Organic solvents, especially preferably water-soluble solvents such as glycerin, ethylene glycol, or propylene glycol can be contained as additional co-solvents in a quantity of from 0.1 to 15 wt. %, or preferably of from 1 to 10 wt. %. The composition can be in a pH range of 4 to 9. A pH range of between 4.5 and 7.5 is particularly preferred. The pH value can be set using typical, known acids or bases, e.g., using citric acid, phosphoric acid, hydrochloric acid, or sodium hydroxide.

An additional embodiment relates to compositions based on oil. These compositions can be used, for example, as shower oils, they contain at least one oil that is liquid at room temperature (20° C.), and they are anhydrous or at least primarily anhydrous with a water content less than 5 wt. %, or preferably less than 2 wt. %.

### Surfactants

The wash-active surfactants are preferably used in a concentration of from 5 to 50 wt. %, or especially preferably of from 10 to 20 wt. % or of from 12 to 18 wt. %. In shower oils, the surfactant content, however, can also be higher, e.g., from 30 to 75 wt. %, with 40 to 65 wt. % being preferred. The surfactants can be anionic, cationic, nonionic, amphoteric, or zwitterionic, wherein anionic, zwitterionic, amphoteric, and nonionic surfactants are preferred. The HLB value of the surfactants to be used is preferably at least 25, but particularly at least 35.

Suitable wash-active anionic surfactants are e.g.:
acylamino acids and salts thereof, e.g., acyl glutamates, particularly sodium acyl glutamate;
sarcosinates, e.g., myristoyl sarcosine, TEA-lauroyl sarcosinate, sodium lauroyl sarcosinate, sodium cocoyl sarcosinate;
acylisethionates, e.g., sodium/ammonium cocoyl isethionate;
sulfosuccinates, e.g., dioctyl sodium sulfosuccinate, disodium laureth sulfosuccinate, disodium lauryl sulfosuccinate, disodium undecylenamido MEA-sulfosuccinate, disodium PEG-5 laurylcitrate sulfosuccinate, and derivatives;
alkylether sulfates, e.g., sodium-, ammonium-, magnesium-, MIPA-, and TIPA-laurethsulfate, sodium myreth sulfate, sodium C₁₂₋₁₃ parethsulfate;
alkylsulfates, e.g., sodium-, ammonium-, and TEA-laurylsulfate;
taurates, e.g., sodium lauroyl taurate, sodium methyl cocoyl taurate;
ether carboxylic acids, e.g., sodium laureth-13 carboxylate, sodium PEG-6 cocamide carboxylate, sodium PEG-7-olive oil carboxylate;
phosphoric acid esters and salts thereof, particularly mono-, di-, and/or triesters of phosphoric acid with addition products of from 2 to 30 mol ethylene oxide to C8 to C22 fatty alcohols, e.g., DEA-oleth-10 phosphate, dilaureth-4 phosphate;
alkylsulphonates, e.g., sodium cocomonoglyceride sulfate, sodium C₁₂₋₁₄ olefin sulfonate, sodium lauryl sulfoacetate, and magnesium PEG-3 cocamide sulfate;
acyl aspartate and glutamates such as di-TEA-palmitoyl aspartate, sodium caprylic/capric glutamate;
acyl peptides, e.g., palmitoyl hydrolyzed lactic protein, sodium cocoyl hydrolyzed soy protein, and sodium/potassium cocoyl hydrolyzed collagen;
carboxylic acids and derivatives, e.g., lauric acid, aluminum stearate, magnesium alkanoate, zinc undecylenate;
ester carboxylic acids, e.g., calcium stearoyl lactylate, laureth-6 citrate, and sodium PEG-4 lauramide carboxylate;
and alkylaryl sulfonates.

Suitable wash-active zwitterionic surfactants or co-surfactants are e.g., surfactants, which contain a quaternary group, i.e., at least one N atom that is covalently connected to 4 alkyl or aryl groups, as well as at least one anionic group, e.g., a carboxylate, sulfate, sulfonate, or phosphate group. Betaines and sultaines such as, for example, alkyl betaine, alkyl amido propyl betaine, or alkyl amido propyl hydroxy sultaine are particularly advantageous. Suitable zwitterionic surfactants are, for example, derivatives of aliphatic quaternary ammonium, phosphonium, and sulfonium compounds of the formula

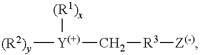

wherein R¹ represent a straight-chain or branched-chain alkyl, alkenyl, or hydroxyalkyl group with 8 to 18 C atoms and 0 to about 10 ethylene oxide units and 0 to 1 glycerol units; Y is an N-, P- or S-containing group; R² is an alkyl or monohydroxyalkyl group with 1 to 3 C atoms; the total of x+y equals 2 if Y is a sulfur atom, and the total of x+y equals 3 if Y is a nitrogen atom or a phosphorus atom; R³ is an alkylene or hydroxyalkylene group with 1 to 4 C atoms, and Z⁽⁻⁾ represents a carboxylate, sulfate, phosphonate, or phosphate group. Other amphoteric surfactants such as betaines are also suitable. Examples of betaines include C8 to C18 alkylbetaines such as cocodimethylcarboxymethylbetaine, lauryldimethylcarboxymethylbetaine, lauryldimethyl-alpha-carboxyethylbetaine, cetyldimethylcarboxymethylbetaine, oleyldimethylgammacarboxypropylbetaine, and lauryl-bis-(2-hydroxypropyl)-alpha-carboxyethylbetaine; C8 to C18 sulfobetaines such as cocodimethylsulfopropylbetaine, stearyldimethylsulfopropylbetaine, lauryldimethylsulfoethylbetaine, lauryl-bis-(2-hydroxyethyl)sulfopropylbetaine; the carboxyl derivatives of imidazole, C8 to C18 alkyldimethylammonium acetate, C8 to C18 alkyldimethylcarbonylmethylammonium salts, as well as C8 to C18 fatty acid alkylamidobetaines such as, for example, coconut fatty acid amidopropylbetaine and N-coconut fatty acid amidoethyl-N[2-(carboxymethoxy)ethyl]-glycerin (CTFA name: Cocoamphocarboxyglycinate).

Suitable wash-active amphoteric surfactants are, for example, acyl dialkyl ethylenediamines, sodium acyl amphoacetate, disodium acyl amphodipropionate, disodium alkyl amphodiacetate, sodium acyl amphohydroxypropylsulfonate, disodium acyl amphodiacetate, sodium acyl amphopropionate, N-alkyl amino acids, e.g., aminopropyl alkyl glutamide, alkylamino propionic acid, sodium alkylimido dipropionate, lauroampho carboxy glycinate, N-coco fatty acid amido ethyl-N-hydroxy ethyl glycinate, and derivatives thereof.

Suitable wash-active nonionic surfactants or co-surfactants are e.g.:
alkanolamides, such as cocamide MEA/DEA/MIPA;
esters resulting from esterification of carboxylic acids with ethylene oxide, glycerin, sorbitan, or other alcohols;
ethoxylated compounds, e.g., ethoxylated fatty alcohols, ethoxylated fatty acids, ethoxylated fatty acid glycerides, ethoxylated alkyl phenols, ethoxylated polysiloxanes, particularly addition products of 2 to 30 mol ethylene oxide and/or 1 to 5 mol propylene oxide to C8 to C22 fatty alcohols, to C12 to C22 fatty acids, or to alkyl phenols with 8 to 15 C atoms in the alkyl group;
propoxylated POE ether;
fatty acid sugar esters, especially esters from saccharose and one or two C8 to C22 fatty acids, INCI: Sucrose Cocoate, Sucrose Dilaurate, Sucrose Distearate, Sucrose Laurate, Sucrose Myristate, Sucrose Oleate, Sucrose Palmitate, Sucrose Ricinoleate, Sucrose Stearate;
esters from sorbitan and one, two or three C8 to C22 fatty acids and a degree of ethoxylation of 4 to 20;
polyglyceryl fatty acid esters, especially from one, two or more C8 to C22 fatty acids and polyglycerol with preferably 2 to 20 glyceryl units;
alkylglucosides, alkyloligoglucosides, and alkylpolyglucosides with C8 to C22 alkyl groups, e.g., decyl glucoside, lauryl glucoside, or coco glucosides;
C12 to C22 fatty acid mono- and diesters of addition products of 1 to 30 mol ethylene oxide to glycerol;
addition products of 5 to 60 mol ethylene oxide to castor oil or hydrogenated castor oil.

Other suitable surfactants are alkylamines, alkylimidazoles, ethoxylated amines, and salts thereof as well as amine oxides, e.g., cocoamidopropylamine oxide.

According to the invention, surfactant combinations of anionic surfactants, particularly lauryl ether sulfates, lauryl sulfates, lauryl ether sulfosuccinates, and zwitterionic or amphoteric surfactants, particularly cocoamphoacetates and cocamidopropyl betaine, are advantageous.

In one embodiment, the composition also contains at least one hair- or skin-conditioning or care ingredient. Hair-conditioning agents are understood to be those capable of providing a hair-care or conditioning effect on wet or dry hair when used in a 0.01 to 5% aqueous, alcoholic, or aqueous alcoholic solution or dispersion, e.g., those that improve the hold or ability to comb or increase the shine. Hair-conditioning agents are, in particular, those for which the function “Hair Conditioning Agents” is indicated in the International Cosmetic Ingredient Dictionary and Handbook, 10th edition, 2004. These additives can (unless indicated otherwise) e.g., be contained in quantities of from 0.01 to 5 wt. %, of from 0.1 to 4 wt. %, or of from 0.2 to 2 wt. %. The additives can, in particular, be selected from cationic polymers, silicone compounds, anti-dandruff ingredients, plant extracts, protein hydrolysates, and amino acids.

### Cationic Polymers

In one embodiment, the agent according to the invention, as a hair-conditioning additive, contains at least one cationic polymer, i.e., a polymer with groups that are cationic or can be cationized, particularly primary, secondary, tertiary, or quaternary amine groups, preferably in a quantity of from 0.01 to 5 wt. % or of from 0.05 to 2 wt. %, or of from 0.1 to 1 wt. %. The cationic charge density is preferably 1 to 7 meq/g.

Suitable cationic polymers preferably contain quaternary amino groups. Cationic polymers can be homo- or copolymers, where the quaternary nitrogen groups are contained either in the polymer chain or preferably as substituents on one or more of the monomers. The monomers containing ammonium groups can be copolymerized with non-cationic monomers. Suitable cationic monomer are unsaturated compounds that can undergo radical polymerization, which bear at least one cationic group, especially ammonium-substituted vinyl monomers such as, for example, trialkylmethacryloxyalkylammonium, trialkylacryloxyalkylammonium, dialkyldiallyl ammonium and quaternary vinylammonium monomers with cyclic, cationic nitrogen-containing groups such as pyridinium, imidazolium or quaternary pyrrolidones, e.g., alkylvinylimidazolium, alkylvinylpyridinium, or alkylvinylpyrrolidone salts. The alkyl groups of these monomers are preferably lower alkyl groups such as, for example, C1 to C7 alkyl groups, and especially preferred are C1 to C3 alkyl groups.

The monomers containing ammonium groups can be copolymerized with non-cationic monomers. Suitable comonomers are, for example, acrylamide, methacrylamide, alkyl- and dialkylacrylamide, alkyl- and dialkylmethacrylamide, alkyl acrylate, alkyl methacrylate, vinylcaprolactone, vinylcaprolactam, vinylpyrrolidone, vinyl esters, for example vinyl acetate, vinyl alcohol, propylene glycol or ethylene glycol, wherein the alkyl groups of these monomers are preferably C1 to C7 alkyl groups, and especially preferred are C1 to C3 alkyl groups.

Suitable polymers with quaternary amine groups are, for example, the polymers described in the CTFA Cosmetic Ingredient Dictionary under the designations Polyquaternium such as Polyquaternium-2 (urea, N,N′-bis[3-(dimethylamino)propyl]-, polymer with 1,1′-oxybis(2-chloroethane); Mirapol® A-15), Polyquaternium-5 (acrylamide, β-methacryloxyethyl triethyl ammonium methosulfate), Polyquaternium-6 (N,N-dimethyl-N-2-propenyl-2-propene aminium chloride), Polyquaternium-7 (N,N-dimethyl-N-2-propenyl-2-propene aminium chloride, 2-propene amide), Polyquaternium-10 (quaternary ammonium salt of hydroxyethyl cellulose), Polyquaternium-11 (vinyl pyrrolidone/dimethylaminoethyl methacrylate copolymer, diethylsulfate reaction product), Polyquaternium-16 (vinyl pyrrolidone/vinyl imidazolinum methochloride copolymer), Polyquaternium-17, Polyquaternium-19 (quaternized water-soluble polyvinylalcohol), Polyquaternium-20 (quaternized polyvinyl octadecyl ether that can be dispersed in water), Polyquaternium-21 (polysiloxane polydimethyl dimethyl ammonium acetate copolymer), Polyquaternium-22 (dimethyldiallyl ammonium chloride/acrylic acid copolymer), Polyquaternium-24 (polymer-type quaternary ammonium salt of hydroxyethyl cellulose), Polyquaternium-28 (vinyl pyrrolidone/methacrylamide propyl trimethylammonium chloride copolymer), Polyquaternium-29 (chitosan converted with propylene oxide and quaternized with epichlorohydrin), Polyquaternium-31, Polyquaternium-32, Polyquaternium-37, Polyquaternium-44 (copolymer-type quaternary ammonium salt of vinyl pyrrolidone and quaternized imidazoline), Polyquaternium-47, and Polyquaternium-57.

Preferred Cationic Polymers of Synthetic Origin:

poly(dimethyldiallyl ammonium chloride); copolymers from acrylamide and dimethyldiallyl ammonium chloride; copolymers from acrylic acid and dimethyldiallyl ammonium chloride; copolymer quaternized with diethylsulfate from vinyl pyrrolidone and dimethylaminoethyl methacrylate, particularly vinyl pyrrolidone/dimethylaminoethyl methacrylate methosulfate copolymer (e.g., Gafquat® 755 N, Gafquat® 734); copolymers from quaternized vinylimidazole and vinyl pyrrolidone, e.g., quaternary ammonium polymers from methylvinylimidazolium chloride and vinyl pyrrolidone (e.g., LUVIQUAT® HM 550); Polyquaternium-35; Polyquaternium-57; polymer from trimethyl ammonium ethyl methacrylate chloride; terpolymers from dimethyldiallyl ammonium chloride, sodium acrylate, and acrylamide (e.g., Merquat® Plus 3300); copolymers from vinyl pyrrolidone, dimethylaminopropyl methacrylamide, and methacryloylamino propyl lauryl dimethyl ammonium chloride; terpolymers from vinyl pyrrolidone, dimethylaminoethyl methacrylate, and vinyl caprolactam (e.g., Gaffix® VC 713); vinyl pyrrolidone/methacrylamide propyl trimethylammonium chloride copolymers (e.g., Gafquat® HS 100); copolymers from vinyl pyrrolidone and dimethylaminoethyl methacrylate; copolymers from vinyl pyrrolidone, vinyl caprolactam, and dimethylaminopropylacrylamide; poly- or oligoesters, constructed from at least one first type of monomer, which is selected from hydroxy acid substituted with at least one quaternary ammonium group; and dimethylpolysiloxanes terminally substituted with quaternary ammonium groups.

Suitable cationic polymers that are derived from natural polymers are especially cationic derivatives of polysaccharides, for example, cationic derivatives of cellulose, starch or guar. Furthermore, chitosan and chitosan derivatives are also suitable. Cationic polysaccharides are, for example, represented by the general formula

G-O—B—N⁺R^{a}R^{b}R^{c}X⁻

G is an anhydroglucose residue, for example, starch or cellulose anhydroglucose;
B is a divalent linking group, for example alkylene, oxyalkylene, polyoxyalkylene or hydroxyalkylene;
R^{a}, R^{b}, and R^{c}, independently from one another, are alkyl, aryl, alkylaryl, arylalkyl, alkoxyalkyl, or alkoxyaryl, any of which can have up to 18 C atoms, wherein the total number of C atoms in R^{a}, R^{b}, and R^{c} is preferably a maximum of 20;
X is a conventional counter-anion, for example, a halide, acetate, phosphate, nitrate, or alkyl sulfate, preferably a chloride. Cationic celluloses are, for example, those with the INCI names Polyquaternium-4, Polyquaternium-10, or Polyquaternium-24. A suitable cationic guar derivative has, for example, the INCI designation Guar Hydroxypropyltrimonium Chloride.

Especially preferred cationically-active substances are chitosan, chitosan salts and chitosan derivatives. Chitosans that can be used according to the invention can be fully or partially deacetylated chitins. By way of example, the molecular weight can be distributed over a broad range, from 20,000 to about 5 million g/mol, for example from 30,000 to 70,000 g/mol. However, the molecular weight will preferably lie above 100,000 g/mol, and especially preferred from 200,000 to 700,000 g/mol. The degree of deacetylation is preferably from 10 to 99%, and especially preferably from 60 to 99%. A preferred chitosan salt is chitosonium pyrrolidone carboxylate, e.g., Kytamer® PC with a molecular weight of from about 200,000 to 300,000 g/mol and a degree of deacetylation of from 70 to 85%. Chitosan derivatives that can be considered include quaternized, alkylated or hydroxyalkylated derivatives, e.g., hydroxyethyl, hydroxypropyl or hydroxybutyl chitosan. The chitosans or chitosan derivatives are preferably present in their neutralized or partially neutralized form. The degree of neutralization will be preferably at least 50%, especially preferably between 70 and 100%, as calculated on the basis of the number of free base groups. For the neutralization agent, in principle any cosmetically compatible inorganic or organic acids can be used such as, for example, formic acid, tartaric acid, malic acid, lactic acid, citric acid, pyrrolidone carboxylic acid, hydrochloric acid and others, of which pyrrolidone carboxylic acid is especially preferred.

Preferred Cationic Polymers Derived from Natural Sources:

cationic cellulose derivatives from hydroxyethyl cellulose and diallyldimethyl ammonium chloride; cationic cellulose deviates from hydroxyethyl cellulose and trimethylammonium-substituted epoxide; chitosan and its salts; hydroxyalkyl chitosans and their salts; alkylhydroxyalkyl chitosans and their salts; N-hydroxyalkylchitosan alkyl ethers.

Particularly advantageous cationic polymers are quaternized cellulose and quaternized guar gum, particularly guar hydroxy propyl ammonium chloride (e.g., Jaguar Excel®, Jaguar C 162® sold by Rhodia, CAS 65497-29-2, and CAS 39421-75-5). Preferred cationic polymers according to the invention are Polyquaternium-10, Polyquaternium-22, Polyquaternium-44, and Jaguar Excel®. Polyquaternium-10 (e.g., Ucare Polymer JR-125® and Ucare Polymer JR-400®, Amerchol) in conjunction with Jaguar Excel® is particularly preferred according to the invention.

### Silicone Compounds

In one embodiment, the agent according to the invention contains, as a hair-conditioning ingredient, at least one silicone compound preferably in a quantity of from 0.01 to 15 wt. %, with 0.1 to 5 wt. % being particularly preferred. The silicone compounds include volatile and nonvolatile silicones and silicones that are soluble and insoluble in the agent. One embodiment is high-molecular-weight silicone with a viscosity of 1,000 to 2,000,000 cSt at 25° C., or preferably 10,000 to 1,800,000 or 100,000 to 1,500,000. The silicone compounds include polyalkyl and polyaryl siloxanes, particularly with methyl, ethyl, propyl, phenyl, methylphenyl, and phenylmethyl groups. Polydimethyl siloxanes, polydiethyl siloxanes, and polymethylphenyl siloxanes are preferred. Also preferred are shine-providing, arylated silicones with a refractive index of at least 1.46 or at least 1.52. The silicone compounds include, in particular, the materials with the INCI designations Cyclomethicone, Dimethicone, Dimethiconol, Dimethicone Copolyol, Phenyl Trimethicone, Amodimethicone, Trimethylsilylamodimethicone, Stearyl Siloxysilicate, Polymethylsilsesquioxane, and Dimethicone Crosspolymer. Silicone resins and silicone elastomers are also suitable, wherein these are highly crosslinked siloxanes. Crosslinked silicones can be used simultaneously to provide consistency to the preferably creamy, solid, or highly viscous composition. Crosslinked silicones are, for example, those with the INCI designations Acrylates/Bis-Hydroxypropyl Dimethicone Crosspolymer, Butyl Dimethiconemethacrylate/Methyl Methacrylate Crosspolymer, C30-45 Alkyl Cetearyl Dimethicone Crosspolymer, C30-45 Alkyl Dimethicone/Polycyclohexene Oxide Crosspolymer, Cetearyl Dimethicone/Vinyl Dimethicone Crosspolymer, Dimethicone Crosspolymer, Dimethicone Crosspolymer-2, Dimethicone Crosspolymer-3, Dimethicone/Divinyldimethicone/Silsesquioxane Crosspolymer, Dimethicone/PEG-10/15 Crosspolymer, Dimethicone/PEG-15 Crosspolymer, Dimethicone/PEG-10 Crosspolymer, Dimethicone/Phenyl Vinyl Dimethicone Crosspolymer, Dimethicone/Polyglycerin-3 Crosspolymer, Dimethicone/Titanate Crosspolymer, Dimethicone/Vinyl Dimethicone Crosspolymer, Dimethicone/Vinyltrimethylsiloxysilicate Crosspolymer, Dimethiconol/Methylsilanol/Silicate Crosspolymer, Diphenyl Dimethicone Crosspolymer, Diphenyl Dimethicone/Vinyl Diphenyl Dimethicone/Silsesquioxane Crosspolymer, Divinyldimethicone/Dimethicone Crosspolymer, Lauryl Dimethicone PEG-15 Crosspolymer, Lauryl Dimethicone/Polyglycerin-3 Crosspolymer, Methylsilanol/Silicate Crosspolymer, PEG-10 Dimethicone Crosspolymer, PEG-12 Dimethicone Crosspolymer, PEG-10 Dimethicone/Vinyl Dimethicone Crosspolymer, PEG-10/Lauryl Dimethicone Crosspolymer, PEG-15/Lauryl Dimethicone Crosspolymer, Silicone Quaternium-16/Glycidoxy Dimethicone Crosspolymer, Styrene/Acrylates/Dimethicone Acrylate Crosspolymer, Trifluoropropyl Dimethicone/PEG-10 Dimethicone Crosspolymer, Trifluoropropyl Dimethicone/Trifluoropropyl Divinyldimethicone Crosspolymer, Trifluoropropyl Dimethicone/Vinyl Trifluoropropyl Dimethicone/Silsesquioxane Crosspolymer, Trimethylsiloxysilicate/Dimethicone Crosspolymer, Trimethylsiloxysilicate/Dimethiconol Crosspolymer, Vinyl Dimethicone/Lauryl Dimethicone Crosspolymer, Vinyl Dimethicone/Methicone Silsesquioxane Crosspolymer, and Vinyldimethyl/Trimethylsiloxysilicate Stearyl Dimethicone Crosspolymer.

Preferred silicones are: cyclic dimethyl siloxanes, linear polydimethyl siloxanes, block polymers from polydimethyl siloxane and polyethylene oxide and/or polypropylene oxide, polydimethyl siloxanes with terminal or lateral polyethylene oxide or polypropylenoxide radicals, polydimethyl siloxanes with terminal hydroxyl groups, phenyl-substituted polydimethyl siloxanes, silicone emulsions, silicone elastomers, silicone waxes, silicone gums, amino-substituted silicones, silicones substituted with quaternary ammonia groups, and crosslinked silicones.

Cation-active silicone compounds are also especially preferred. These compounds are substituted with cationic groups or cationisable groups. Suitable cation-active silicone compounds either have at least one amino group or at least one ammonium group. Silicone polymers with amino groups are known under the INCI designations Amodimethicone and Trimethylsilylamodimethicone. These polymers are polydimethylsiloxanes with aminoalkyl groups. The aminoalkyl groups can be lateral or terminal. Suitable amino silicones are as those of the general formula

R⁸R⁹R¹⁰Si—(OSiR¹¹R¹²)x—(OSiR¹³Q)y—OSiR¹⁴R¹⁵R¹⁶

R⁸, R⁹, R¹⁴, and R¹⁵, independently from one another, are the same or different and mean C1 to C10 alkyl, phenyl, hydroxy, hydrogen, C1 to C10 alkoxy or acetoxy, or preferably C1-C4 alkyl, and especially preferably methyl or trimethylsilyl;
R¹⁰ and R¹⁶, independently from one another, are the same or different and mean —(CH₂)ₐ—NH₂, with a being equal to 1 through 6, C1 to C10 alkyl, phenyl, hydroxy, hydrogen, C1 to C10 alkoxy or acetoxy, or preferably C1-C4 alkyl, and especially preferably methyl;
R¹¹, R¹² and R¹³, independently from one another, are the same or different and mean hydrogen, C1 to C20 hydrocarbon, which can contain O and N atoms, or preferably C1 to C10 alkyl or phenyl, or especially preferably C1 to C4 alkyl, but particularly methyl;
Q means -A-NR¹⁷R¹⁸ or -A-N⁺R¹⁷R¹⁸R¹⁹, wherein A stands for a divalent C1 to C20 alkylene compound group, which can also contain O and N atoms as well as OH groups, and R¹⁷, R¹⁸, and R¹⁹, independently from one another, are the same or different and mean hydrogen, C1 to C22 hydrocarbon, or preferably C1 to C4 alkyl or phenyl. Preferred radicals for Q are —(CH₂)₃—NH₂, —(CH₂)₃NHCH₂CH₂NH₂, —(CH₂)₃OCH₂CHOHCH₂NH₂ and —(CH₂)₃N(CH₂CH₂OH)₂, —(CH₂)₃—NH₃⁺ and —(CH₂)₃OCH₂CHOHCH₂N⁺(CH₃)₂R²⁰, wherein R²⁰ is a C1 to C22 alkyl group, which can also have OH groups; x means a number between 1 and 10,000, or preferably between 1 and 1,000; y means a number between 1 and 500, or preferably between 1 and 50. The molecular weight of the amino silicone is preferably between 500 and 100,000. The amine portion (meq/g) preferably ranges between 0.05 to 2.3, with 0.1 to 0.5 being particularly preferred.

Suitable silicone polymers with two terminal quaternary ammonium groups are known under the INCI designation Quaternium-80. These are dimethylpolysiloxanes with 2 terminal alkyl ammonium groups. Suitable quaternary amino silicones are those of the general formula

R²¹R²²R²³N⁺-A-SiR⁸R⁹—(OSiR¹¹R¹²)ₙ—OSiR⁸R⁹-A-N⁺R²¹R²²R²³2X—

A stands for a divalent C1 to C20 alkylene compound group, which can also contain O and N atoms as well as OH groups and is preferably —(CH₂)₃OCH₂CHOHCH₂;
R⁸ and R⁹, independently from one another, are the same or different and mean C1 to C10 alkyl, phenyl, hydroxy, hydrogen, C1 to C10 alkoxy or acetoxy, or preferably C1-C4 alkyl, or especially preferably methyl;
R¹¹ and R¹², independently from one another, are the same or different and mean hydrogen, C1 to C20 hydrocarbon, which can contain O and N atoms, or preferably C1 to C10 alkyl or phenyl, or especially preferably C1 to C4 alkyl, but particularly methyl;
R²¹, R²², and R²³, independently from one another, mean C1 to C22 alkyl groups, which can contain hydroxyl groups and wherein preferably at least one of the groups has at least 10 C atoms and the remaining groups have 1 to 4 C atoms; n is a number of from 0 to 200, or preferably 10 to 100. These types of diquaternary polydimethylsiloxanes are sold by GOLDSCHMIDT in Germany under the trade names Abil® Quat 3270, 3272, and 3274.

### Plant Extracts

Suitable conditioning plant extracts are typically produced by extracting the entire plant. However, in individual cases, it can be preferable to produce the extracts exclusively from seeds and/or leaves of plants. Primarily preferred according to the invention are the extracts from green tea, oak bark, stinging nettles, witch hazel, hops, henna, chamomile, burdock root, horsetail, hawthorn, linden blossom, almonds, aloe vera, pine needles, horse chestnut, sandalwood, juniper, coconut, mango, apricot, lemon, wheat, kiwi, melon, orange, grapefruit, sage, rosemary, birch, mallow, lady's smock, wild thyme, yarrow, thyme, melissa, restharrow, coltsfoot, marshmallow, meristem, ginseng, and ginger root. Water, alcohols, as well as mixtures thereof can be used as extraction agents for producing the plant extracts mentioned. Preferred alcohols are lower alcohols such as ethanol and isopropanol, but particularly polyvalent alcohols such as ethylene glycol and propylene glycol, both as a stand-alone extraction agent as well as in a mixture with water, e.g., plant extracts based on water/propylene glycol in a 1:10 to 10:1 ratio. The plant extracts can be used in a pure or diluted form. If they are used in diluted form, they typically contain approx. 2 to 80 wt. % of active substance and the extraction agent or extraction agent mixture used in their recovery as a solvent. Mixtures of multiple, particularly of two, different plant extracts can also be used.

### Protein Hydrolysates and Amino Acids

Additional suitable hair-conditioning agents are protein hydrolysates and amino acids. Protein hydrolysates in terms of the invention are understood to be protein hydrolysates and/or amino acids and derivatives thereof. Derivatives are, for example, condensation products with fatty acids or cationically modified protein hydrolysates. Protein hydrolysates are product mixtures, which are obtained by decomposition (due to acidic, alkaline, or enzymatic catalysis) of proteins. The term protein hydrolysates is also understood to include total hydrolysates as well as individual amino acids and derivatives thereof as well as mixtures of various amino acids. Amino acids are, for example, alanine, arginine, asparagine, asparagine acid, cystine, glutamine, glutamine acid, glycine, histidine, isoleucine, leucine, lysine, methionine, phenylalanine, proline, serine, threonine, tryptophan, tyrosine, and valine. Furthermore, polymers constructed from amino acids and amino acid derivatives according to the present invention are included in the term protein hydrolysates. The latter includes, for example, polyalanine, polyasparagine, polyserine, etc. Other examples are L-alanyl-L-proline, polyglycine, glycyl-L-glutamine, or D/L-methionine-5-methylsulfonium chloride. B-amino acids and derivatives thereof such as B-alanine, anthranilic acid, or hippuric acid can also be used. The molar mass of the protein hydrolysates is between 75, the molar mass for glycine, and 200,000; the molar mass is preferably 75 to 50,000 and especially preferably 75 to 20,000 Dalton.

According to the invention, protein hydrolysates of plant, animal, marine, or synthetic origin can be used. Animal protein hydrolysates are, for example, elastin, collagen, keratin, silk, and lactoprotein hydrolysates, which can also be in the form of salts. According to the invention, the use of protein hydrolysates of plant origin, e.g., soy, almond, pea, potato, rice, and wheat protein hydrolysates as well as their condensation products with fatty acids are preferred. Even though the use of protein hydrolysates as such is preferred, if necessary, other obtained amino acid mixtures can be used in their place.

Suitable cationically derived protein hydrolysates are substance mixtures, which, for example, can be obtained by converting alkaline, acidic, or enzyme hydrolyzed proteins with glycidyl trialkyl ammonium salts or 3-halo-2-hydroxypropyl trialkyl ammonium salts. Proteins that are used as starting materials for the protein hydrolysates can be of plant or animal origin. Standard starting materials are, for example, keratin, collagen, elastin, soy protein, rice protein, lactoprotein, wheat protein, silk protein, or almond protein. The hydrolysis results in material mixtures with mole masses in the range of approx. 100 to approx. 50,000. Customary, mean mole masses are in the range of about 500 to about 1,000. It is advantageous if the cationically derived protein hydrolysates have one or two long C8 to C22 alkyl chains and two or one short C1 to C4 alkyl chain accordingly. Compounds containing one long alkyl chain are preferred. Cationic protein derivatives are known, for example, under the INCI designations Lauryldimonium Hydroxypropyl Hydrolyzed Wheat Protein, Lauryldimonium Hydroxypropyl Hydrolyzed Casein, Lauryldimonium Hydroxypropyl Hydrolyzed Collagen, Lauryldimonium Hydroxypropyl Hydrolyzed Keratin, Lauryldimonium Hydroxypropyl Hydrolyzed Silk, Lauryldimonium Hydroxypropyl Hydrolyzed Soy Protein or Hydroxypropyltrimonium Hydrolyzed Wheat, Hydroxypropyltrimonium Hydrolyzed Casein, Hydroxypropyltrimonium Hydrolyzed Collagen, Hydroxypropyltrimonium Hydrolyzed Keratin, Hydroxypropyltrimonium Hydrolyzed Rice Bran Protein, Hydroxypropyltrimonium Hydrolyzed Silk, Hydroxypropyltrimonium Hydrolyzed Soy Protein, and Hydroxypropyltrimonium Hydrolyzed Vegetable Protein.

### Anti-Dandruff Ingredients

In one embodiment, the agent according to the invention contains at least one anti-dandruff ingredient preferably in a quantity of from 0.01 to 10 wt. %, or particularly of from 0.05 to 5 wt. %. Anti-dandruff ingredients are, for example, those for which the function “Antidandruff Agent” is indicated in the International Cosmetic Ingredient Dictionary and Handbook, 10th edition, particularly acetylsalicylic acid (synonym 2-acetoxy benzoic acid), bis(1-hydroxy-2-(1H)-pyridinethionato)zinc (INCI designation: Zinc Pyrithione), 1-(4-chlorophenoxy)-1-(1-imidazolyl)-3,3-dimethyl-2-butanone (INCI designation: Climbazole), and 1-hydroxy-4-methyl-6-(2,4,4-trimethylpentyl)-2(1H)-pyridinone, 2-ethanolamine salt (INCI designation: Piroctone Olamine), salicylic acid, sulfur, tar preparations, undecenoic acid derivatives, hinokitiol, as well as those from the group of natural materials such as, for example, extracts of arnica, birch, burr root, poplar, stinging nettle, willow bark, or walnut shell.

### Pearl-Shine and Opacifying Agents

In one embodiment, the agent according to the invention contains at least one turbidity and/or pearl-shine agent preferably in a quantity of from 0.01 to 10 wt. %, or particularly of 0.1 to 5 wt. %. Opacifying agents in this case are understood to be substances and substance mixtures according to the invention that provide the preparation with a turbid, emulsion-type appearance. Pearl-shine agents in this case are substances and substance mixtures according to the invention that provide the preparation an opalescent appearance. Mixtures of turbidity and pearl-shine agents can also be used. Turbidity and pearl-shine agents and/or mixtures are e.g.:
PEG-3 distearate (e.g., CUTINA TS sold by Cognis);
a combination of glycol distearate, glycerin, laureth-4, and cocamidopropyl betaine (e.g., Euperlan PK 3000 and Euperlan PK 4000 sold by Cognis);
a combination of glycol distearate, cocosglucosides, glyceryl oleate, and glyceryl stearate (e.g., Lamesoft TM Benz sold by Cognis);
styrene/acrylate copolymers (e.g., Acusol OP 301 from Rohm & Haas).

### Thickeners

The preferred highly viscous or non-fluid consistency can be set with suitable thickeners or gel-formers preferably in a quantity of from 0.01 to 10 wt. % or 0.05 to 5 wt. % or especially preferably of from 0.1 to 3 wt. %. Salts can also be used for this. Preferred salts are alkali metal or alkaline earth metal halides. Sodium chloride is especially preferred. Preferred salt quantities range from 0.1 to 3 wt. %.

Thickeners indicated as a “Viscosity Increasing Agent” in the International Cosmetic Ingredient Dictionary and Handbook, 10th edition, 2004 are essentially suitable. The thickener or gel-former can be an inorganic thickener but is preferably a thickened organic polymer and is especially preferably selected from copolymers consisting of at least one first type of monomer, which is selected from acrylic acid and methacrylic acid, and at least one second type of monomer, which is selected from esters of acrylic acid and ethoxylated fatty alcohol; crosslinked polyacrylic acid; crosslinked copolymers consisting of at least one first type of monomer, which is selected from acrylic acid and methacrylic acid, and at least one second type of monomer, which is selected from esters of acrylic acid with C10 to C30 alcohols; copolymers consisting of at least one first type of monomer, which is selected from acrylic acid and methacrylic acid, and at least one second type of monomer, which is selected from esters of itaconic acid and ethoxylated fatty alcohol; copolymers consisting of at least one type of monomer, which is selected from acrylic acid and methacrylic acid, at least one second type of monomer, which is selected from esters of itaconic acid and ethoxylated C10 to C30 alcohol, and a third type of monomer, which is selected from C1 to C4 aminoalkyl acrylates; copolymers consisting of two or more monomers, which are selected from acrylic acid, methacrylic acid, acrylic acid esters and methacrylic acid esters; copolymers consisting of vinyl pyrrolidone and ammonium acryloyl dimethyltaurate; copolymers consisting of ammonium acryloyl dimethyltaurate and monomers selected from esters of methacrylic acid and ethoxylated fatty alcohols; hydroxyethyl cellulose; hydroxypropyl cellulose; methyl cellulose, carboxy methyl cellulose, hydroxy propyl methyl cellulose, hydroxypropyl guar; glyceryl polyacrylate; glyceryl polymethacrylate; copolymers consisting of at least one C2, C3, or C4 alkylene and styrene; polyurethane; hydroxypropyl starch phosphate; polyacrylamide; copolymers crosslinked with decadiene consisting of maleic acid anhydride and methyl vinyl ether; locust bean gum; guar gum; xanthan; dehydroxanthan; carrageenan; karaya gum; hydrolyzed corn starch; copolymers consisting of polyethylene oxide, fatty alcohols, and saturated methylene diphenyl diisocyanate (e.g., PEG-150/stearyl alcohol/SMDI copolymer), polyvinyl alcohols, PVP, PVP/VA copolymers, and polyglycols.

Inorganic thickeners are, for example, silica gels, layer silicates, naturally occurring and synthetic aluminas such as, for example, montmorillonite, bentonite, hectorite, laponite, and magnesium aluminum silicates such as Veegum®. These substances can be used as is or in a modified form as a thickener such as, for example, stearylalkonium hectorites.

In one embodiment, the agent according to the invention contains 0.01 to 5 wt. %, or especially preferably 0.05 to 1 wt. %, of at least one preservative. Suitable preservatives are those materials listed with the “Preservatives” function in the International Cosmetic Ingredient Dictionary and Handbook, 10th edition, e.g., phenoxyethanol, benzylparaben, butylparaben, ethylparaben, isobutylparaben, isopropylparaben, methylparaben, propylparaben, iodopropynyl butylcarbamate, methyldibromoglutaronitrile, and DMDM hydantoin.

The cosmetic composition to be used according to the invention can also contain additional active ingredients or additives for the hair or skin/scalp. These active ingredients or additives can, for example, be selected from hair- or skin-care materials, hair-setting materials, photoprotective materials, preservatives, pigments, particle-shaped materials, perfumes and scents, humectants, shine-enhancers, product coloring agents, and antioxidants each in quantities preferably of from 0.01 to 10 wt. %, wherein the total quantity preferably does not exceed 10 wt. %.

A particular embodiment relates to shower oils. The propellant-free basic composition in this case is anhydrous or at least substantially anhydrous. The water content is preferably from 0 to 5 wt. %, or particularly from 0 to 2 wt. %. The surfactant content is preferably from 20 to 75 wt. %, or particularly from 40 to 65 wt. %. The content in oils and other hydrophobic materials such as, for example, fatty alcohols is preferably from 10 to 60 wt. %, or particularly from 30 to 50 wt. %. Preferred propellants for the shower oils are hydrocarbons, particularly with 3 to 5 C atoms such as propane, butane, and pentane. Contrary to watery shampoos, atomization in the form of a fine aerosol spray instead of flakes is possible with these propellants.

Suitable oils are, in particular, liquid, hydrophobic oils having a melting point of less than 25° C. and a boiling point of preferably greater than 250° C., or particularly greater than 300° C. Volatile oils can also be used. In principle, any oil generally known to a person skilled in the art can be used. Suitable oils are vegetable or animal oils, mineral oils (liquid paraffin), or mixtures thereof. Hydrocarbon oils, e.g., paraffin or isoparaffin oils, squalane, fatty acid esters such as, for example, isopropyl myristate, oils from fatty acids and polyolene, particularly triglycerides, are suitable. Suitable plant oils are, for example, sunflower seed oil, coconut oil, castor oil, lanolin oil, jojoba oil, corn oil, soy oil, Kukui nut oil, (sweet) almond oil, walnut oil, peach seed oil, avocado oil, tea tree oil, sesame oil, camellia oil, evening primrose oil, rice bran oil, palm kernel oil, mango seed oil, cuckoo flower oil, thistle oil, macadamia nut oil, grapeseed oil, apricot seed oil, babassu oil, olive oil, wheat germ oil, pumpkin seed oil, mallow oil, hazelnut oil, safflower oil, canola oil, sasanqua oil, and shea butter.

In addition, fatty alcohols can be contained, particularly saturated, mono- or poly-unsaturated, branched or unbranched fatty alcohols with 6 to 30, preferably 10 to 22, and especially preferably 12 to 22 C atoms. The following can be used for example: decanol, octanol, octenol, dodecanol, dodecenol, decenol, octadienol, dodecadienol, decadienol, oleyl alcohol, eruca alcohol, ricinol alcohol, stearyl alcohol, isostearyl alcohol, cetyl alcohol, lauryl alcohol, myristyl alcohol, arachidyl alcohol, capryl alcohol, caprin alcohol, linoleyl alcohol, linolenyl alcohol, and behenyl alcohol, as well as Guerbet alcohols thereof, wherein this list should serve as an example and not be limiting in nature. The fatty alcohols are preferably derived from natural fatty acids, wherein one can assume a recovery from the esters of fatty acids via reduction. Fatty alcohol portions, which are created by the reduction of naturally occurring triglycerides such as beef tallow, palm oil, peanut oil, turnip oil, cottonseed oil, soy oil, sunflower seed oil, and linseed oil or of their transesterification products with fatty acid esters occurring with the corresponding alcohols can be used according to the invention and thus represent a mixture of different fatty alcohols. Wool wax alcohols can also be used according to the invention.

The object of the invention is also a method for hair or skin cleaning, wherein
a product release system according to the invention is provided,
via the product release system, the composition contained therein is sprayed onto the hair or skin, and
after cleaning, the hair or skin is rinsed.

The products according to the invention are characterized, constrained by their special application with the special aerosol spray system to be used according to the invention, by a high level of cleaning and care performance on the hair and on the skin. The advantages with use are characterized by a comfortable application, improved distributability, more economical dispensing, a more pleasant consistency as perceived by the user, and a perceptively more pleasant feel on the skin, with cleaning and care results that are the same as or better than that of conventional products. An additional advantage of the products according to the present invention is that differing spray properties can be precisely adjusted by simply varying the propellant, the propellant composition, or the propellant pressure; these spray properties were not previously possible for the underlying active ingredient compositions. The spray properties include everything from a fine aerosol atomized spray and snow-like drops to flakes of spray, and spray foam.

The following examples should serve to illustrate further the object of the present invention.

### EXAMPLES

In the following examples, the individual active ingredient compositions were adjusted to a pH of approximately 6 using citric acid/NaOH and were filled, along with the individually indicated propellants, into a pressure-resistant aerosol can and equipped with a capillary spray system, as can be obtained, for example, under the trade name TRUSPRAY® from Boehringer Ingelheim microParts GmbH.

### Example 1

### Shampoo for Fine Hair

| Sodium lauryl ether sulfate | 7.7 | g |
|---|---|---|
| Laureth-4 | 3.0 | g |
| PEG-200 hydrogenated glyceryl palmate | 2.8 | g |
| Ammonium lauryl sulfate | 2.75 | g |
| Cocamidopropyl betaine | 2.55 | g |
| PEG-7 glyceryl cocoate | 0.7 | g |
| Hydroxypropyl guar hydroxypropyltrimonium | 0.3 | g |
| chloride | | |
| Polyquaternium-47 | 0.2 | g |
| Hydrolyzed silk protein | 0.01 | g |
| Preservative, perfume | q.s. | |
| Water | balance to 100 | g |

Viscosity (12.9 s⁻¹, (25° C.): 3,247 mPa s)

### Example 2

### Shampoo for Normal Hair

| Sodium lauryl ether sulfate | 8.4 | g |
|---|---|---|
| Disodium lauryl ether sulfosuccinate | 4 | g |
| Cocamidopropyl betaine | 2.25 | g |
| Glycol distearate | 2 | g |
| Hydroxypropyl guar hydroxypropyltrimonium | 0.2 | g |
| chloride | | |
| Sodium chloride | 1.5 | g |
| Laureth-4 | 0.4 | g |
| Creatine | 0.1 | g |
| Preservative, perfume | q.s. | |
| Water | balance to 100 | g |

Viscosity (12.9 s⁻¹, (25° C.): 3,861 mPa s)

### Example 3

### Skin/Scalp Cleaning and Peeling Paste

| Sodium lauryl ether sulfate | 12.3 | g |
|---|---|---|
| Propylene glycol | 1.5 | g |
| Cocamidopropyl betaine | 1.5 | g |
| Acrylates/C10-30 alkyl acrylate crosspolymer | 1 | g |
| PEG-3 Distearate | 1 | g |
| Magnesium lauryl ether sulfate | 0.9 | g |
| Sodium oleyl ether sulfate | 0.4 | g |
| Magnesium oleyl ether sulfate | 0.1 | g |
| Zinc pyrithione | 1 | g |
| Climbazole | 0.6 | g |
| Piroctone olamine | 0.5 | g |
| Polyquaternium-10 | 0.1 | g |
| Preservative, perfume | q.s. | |
| Water | balance to 100 | g |

Viscosity (12.9 s⁻¹, (25° C.)): 5,408 mPa s)

### Example 4

### Hair & Body Gel Shampoo

| | |
|---|---|
| Sodium lauryl ether sulfate | 9.8 |
| PEG-200 hydrogenated glyceryl palmate | 3.36 |
| Ammonium lauryl sulfate | 2.75 |
| Disodium lauryl ether sulfosuccinate | 2.4 |
| Polygel W400 (acrylate copolymer 30%) | 4.5 |
| PEG-7 glyceryl cocoate | 0.84 |
| Panthenol | 0.6 |
| Sodium chloride | 0.5 |
| Polyquaternium-10 | 0.2 |
| L-histidine | 0.1 |
| Preservative, perfume | q.s. |
| Water | balance to 100 g |

Viscosity (12.9 s⁻¹, (25° C.): 2,042 mPa s)
pH value can be adjusted with NaOH and citric acid

### Example 5

### Pasty Shampoo

| | |
|---|---|
| Sodium lauryl ether sulfate | 16 |
| Glycol stearate | 30 |
| Sodium chloride | 0.8 |
| Perfume | 0.4 |
| Polyquaternium-10 | 0.2 |
| Formaldehyde | 0.1 |
| Citric acid | 0.1 |
| Water | balance to 100 g |

Consistency: Pasty, viscosity not measurable
pH value 6.0-7.0

### Example 6

### Creamy Shampoo

| | |
|---|---|
| Sodium lauryl sulfate | 18 |
| Stearic acid | 7.4 |
| Glycol stearate | 2.0 |
| Sodium hydroxide | 0.8 |
| Sodium chloride | 0.6 |
| Lanolin | 0.5 |
| Perfume | 0.2 |
| Trisodium phosphate | 0.1 |
| Water | balance to 100 g |

Consistency: Pasty, viscosity not measurable
pH value 8.65

Fill Ratios in Wt. %:

| Example | Active ingredient solution | propane/butane 4.8 bar | DME |
|---|---|---|---|
| 1-A | 60 | 40 | |
| 1-B | 60 | | 40 |
| 2-A | 60 | 40 | |
| 2-B | 60 | | 40 |
| 3-A | 60 | 40 | |
| 3-B | 60 | | 40 |
| 4-A | 60 | 40 | |
| 4-B | 60 | | 40 |
| 5-A | 60 | 40 | |
| 5-B | 60 | | 40 |
| 6-A | 60 | 40 | |
| 6-B | 60 | | 40 |

When the filling is done with DME, this results in a fine atomized spray with all formulations; the sprayed drops are somewhat larger with 1B. The atomized products foam up well on the scalp or hair together with water. When the filling is done with propane/butane, this results in flakes or snow-like spray that is comparable to artificial snow with all formulations. The small white flakes foam well when combined with water.

Product 3-B containing anti-dandruff agents is particularly advantageous, because it can be sprayed directly at the hair roots in the form of a fine atomized spray despite the pasty, highly viscous starting consistency.

### Example 7

### Shower Oil

| | | |
|---|---|---|
| MIPA laureth sulfate | 24 | g |
| Glycine soya oil | 23 | g |
| Octyldodecanol | 11 | g |
| Cocamide DEA | 9.5 | g |
| Ricinus communis oil | 6 | g |
| Panthenol | 0.8 | g |
| Perfume | 0.8 | g |
| Buxus chinensis oil | 0.6 | g |
| Laureth-4 | balance to 100 | g |

Filling with propane/butane in a ratio of active ingredient composition: propellant=60:40. This results in a fine aerosol spray during atomization.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A product release system for atomizing compositions comprising a pressure-resistant packaging, a spray head comprising a capillary, and a composition comprising a propellant, wherein the atomization occurs using said capillary and wherein said composition comprises at least one wash-active surfactant.

2. A product release system according to claim 1, wherein the capillary has a diameter of 0.1 to 1 mm and a length of 5 to 100 mm.

3. A product release system according to claim 1, wherein the spray rate is 0.01 to 5 g/s.

4. A product release system according to claim 1, wherein the propellant is selected from the group consisting of propane, butane, pentane, dimethyl ether, fluorinated hydrocarbons, and mixtures thereof.

5. A product release system according to claim 1, wherein said at least one wash-active surfactant is used in a quantity of from 5 to 50 wt. % of the propellant-free basic composition, and wherein at least one said wash-active surfactant is selected from the group consisting of anionic wash-active surfactants, zwitterionic wash-active surfactants, amphoteric wash-active surfactants, nonionic wash-active surfactants and mixtures thereof.

6. A product release system according to claim 1, wherein said composition comprises a combination of at least one anionic wash-active surfactant and at least one zwitterionic wash-active surfactant.

7. A product release system according to claim 1, comprising at least one wash-active surfactant selected from the group consisting of lauryl ether sulfates, lauryl sulfates, lauryl ether sulfosuccinates, cocoamphoacetates, and cocamidopropyl betaine.

8. A product release system according to claim 1, wherein said composition is gel-like with a viscosity of at least 1,000 mPa s, measured at 25° C. with a shear rate of 12.9 s⁻¹.

9. A product release system according to claim 1, wherein said composition additionally comprises from 0.01 to 5 wt. %, of the composition without propellant, of at least one active ingredient or auxiliary ingredient, selected from the group consisting of cationic polymers, silicone compounds, thickeners, opacifying agents, pearl-shine agents, anti-dandruff ingredients, and plant extracts.

10. A product release system according to claim 9, wherein said silicone compound is selected from the group consisting of cyclic dimethylsiloxanes, linear polydimethylsiloxanes, block polymers from polydimethylsiloxane and at least one block selected from the group consisting of polyethylene oxide and polypropylene oxide, polydimethylsiloxanes with terminal or lateral residues selected from the group consisting of polyethylene oxide and polypropylene oxide, polydimethylsiloxanes with terminal hydroxyl groups, phenyl-substituted polydimethylsiloxanes, silicone emulsions, silicone elastomers, silicone waxes, silicone gums, amino-substituted silicones, silicones substituted with one or more quaternary ammonium groups, and crosslinked silicones.

11. A product release system according to claim 1, wherein said composition comprises at least one thickener, which is selected from the group consisting of copolymers which are made from at least one first type of monomer and from at least one second type of monomer, wherein said first type of monomer is selected from the group consisting of acrylic acid and methacrylic acid and wherein said second type of monomer is an ethoxylated fatty alcohol acrylic acid ester, crosslinked polyacrylic acid, crosslinked copolymers which are made from at least one first type of monomer, and from at least one second type of monomer, wherein said first type of monomer is selected from the group consisting of acrylic acid and methacrylic acid and wherein said second type of monomer is a C10 to C30 alcohol acrylic acid ester, copolymers made from at least one first type of monomer and from at least one second type of monomer, wherein said first type of monomer is selected from the group consisting of acrylic acid and methacrylic acid and wherein said at least one second type of monomer is selected from esters of itaconic acid and ethoxylated fatty alcohol, copolymers from at least one first type of monomer, from at least one second type of monomer and from at least one third type of monomer, wherein said first type of monomer is selected from the group consisting of acrylic acid and methacrylic acid and wherein said at least one second type of monomer is an ester of itaconic acid and ethoxylated C10 to C30 alcohol and wherein said third type of monomer is a C1 to C4 aminoalkyl acrylate, copolymers from two or more monomers selected from the group consisting of acrylic acid, methacrylic acid, acrylic acid esters, and methacrylic acid esters, copolymers from vinyl pyrrolidone and ammonium acryloyl dimethyltaurate, copolymers from ammonium acryloyl dimethyltaurate and at least one second monomer, wherein said second monomer is an ester of methacrylic acid and ethoxylated fatty alcohol, hydroxyethyl cellulose, hydroxypropyl cellulose, methyl cellulose, carboxy methyl cellulose, hydroxy propyl methyl cellulose, hydroxypropyl guar, glyceryl polyacrylate, glycerylpoly methacrylate, copolymers from at least one first type of monomer and styrene, wherein said first type of monomer is selected from the group consisting of C2 alkylene, C3 alkylene and C4 alkylene, polyurethanes, hydroxypropyl starch phosphate, polyacrylamide, copolymer of maleic acid anhydride and methyl vinyl ether, wherein said copolymer is crosslinked with decadiene, locust bean gum, guar gum, xanthan, dehydroxanthan, carrageenan, karaya gum, hydrolyzed corn starch, copolymers from polyethylene oxide, fatty alcohols, and saturated methylene diphenyl diisocyanate, polyvinyl alcohol, polyvinylpyrrolidone, vinylpyrrolidone/vinylacetate copolymer, polyglycols, salts, and inorganic thickeners.

12. A product release system according to claim 1, wherein the composition comprises at least one cationic polymer, which is selected from the group consisting of quaternized cellulose, quaternized guar gum, poly(dimethyldiallyl ammonium chloride), copolymers from acrylamide and dimethyldiallyl ammonium chloride, copolymers from acrylic acid and dimethyldiallyl ammonium chloride, copolymer quaternized with diethylsulfate from vinyl pyrrolidone and dimethylaminoethyl methacrylate, copolymers from quaternized vinyl imidazolin and vinyl pyrrolidone, Polyquaternium-35, polymer from trimethyl ammonium ethyl methacrylate chloride, Polyquaternium-57, dimethylpolysiloxanes terminally substituted with quaternary ammonium groups, copolymer from vinyl pyrrolidone, dimethylaminopropyl methacrylamide, and methacryloylamino propyl lauryl dimethyl ammonium chloride, chitosan and its salts, hydroxyalkyl chitosans and its salts, alkyl hydroxyalkyl chitosans and their salts, N-hydroxyalkyl chitosan alkyl ether, copolymer from vinyl caprolactam, vinyl pyrrolidone, and dimethylaminoethyl methacrylate, copolymers from vinyl pyrrolidone and dimethylaminoethyl methacrylate, copolymers from vinyl pyrrolidone, vinyl caprolactam, and dimethylaminopropylacrylamide, polyesters, formed from at least one monomer, which is a hydroxy acid that is substituted with at least one quaternary ammonium group, and oligoesters, formed from at least one monomer, which is a hydroxy acid that is substituted with at least one quaternary ammonium group.

13. A product release system according to claim 1, comprising at least one anti-dandruff ingredient selected from the group consisting of acetylsalicylic acid, zinc pyrithione, piroctone olamine, climbazole, salicylic acid, sulfur, tar preparations, undecenoic acid derivatives, hinokitiol, and extracts of natural materials, wherein the extracts of natural materials are selected from the group consisting of arnica extracts, birch extracts, burr root extracts, poplar extracts, stinging nettle extracts, willow bark extracts, and walnut shell extracts.

14. A product release system according to claim 1, wherein said composition is gel-like with a viscosity of at least 1000 mPa s measured at 25° C. with a shear speed of 12.9 s⁻¹, comprising;
(a) from 5 to 30 wt. %, of the composition without propellant, of at least one anionic or zwitterionic wash-active surfactant;
(b) from 0.01 to 5 wt. %, of the composition without propellant, of at least one active ingredient or auxiliary ingredient, selected from the group consisting of cationic polymers, silicone compounds, thickeners, opacifying agents, pearl-shine agents, anti-dandruff ingredients; and
(c) from 15 to 85 wt. %, of the total composition, of at least one propellant, selected from the group consisting of C3 to C5 hydrocarbons and dimethylether.

15. A product release system according to claim 1, wherein the composition comprises;
(a) from 20 to 75 wt. %, of the composition without propellant, of at least one wash-active surfactant;
(b) from 10 to 60 wt. %, in relation to the composition without propellant, of at least one compound selected from the group consisting of oils and fatty alcohols;
(c) from 0 to 5 wt. % of water, and
(c) from 15 to 85 wt. %, of the total composition, of at least one propellant, selected from the group consisting of C3 to C5 hydrocarbons.
